(19) United States
(12) Patent Application Publication
(10) Pub. No.: US 2019/0092452 A1
(43) Pub. Date: Mar. 28, 2019

(54) FLUID-DRIVEN DEVICE

(71) Applicant: Xue Hui XIE, Shanghai (CN)

(72) Inventor: Xue Hui XIE, Shanghai (CN)

(21) Appl. No.: 16/144,296

(22) Filed: Sep. 27, 2018

(30) Foreign Application Priority Data
Sep. 28, 2017 (CN) 201710895459.6

(51) Int. Cl. B64C 11/06; B64C 11/30; B64C 11/36

(52) U.S. Cl. CPC B64C 11/06; B64C 11/36; B64C 11/303

(57) ABSTRACT

A fluid-driven device is provided according to the present disclosure. The fluid-driven device includes: a transmission portion, which is driven to rotate in an axial direction of the transmission portion; blade portions, which are connected to the transmission portion and rotate in the axial direction of the transmission portion to generate a fluid power; and a pitch portion, which is connected to the blade portions and configured to change a frontal area of the blade portion in its rotation direction in the axial direction of the transmission portion so that the frontal area of the blade portion is switched between a maximum frontal area and a minimum frontal area. With the fluid-driven device according to the present disclosure, a frontal area of the blade portion is regulated to be maintained at a maximum frontal area in a desired motion direction for interaction with fluid, and is switched to a minimum frontal area in an undesired motion direction to avoid interaction with the fluid as much as possible. In this way, a resistance caused by the fluid is avoided as much as possible, and an action force generated by the fluid is still applied in the desired motion direction and is maximally utilized to promote a motion.

### FIELD OF THE INVENTION

The present disclosure relates to the field of fluid dynamics, and in particular to a fluid-driven device.

### BACKGROUND OF THE INVENTION

With the social development, many types of vehicles have been devised, covering ground transportation, water transportation and air transportation. For air vehicles, one type of current aircrafts needs to achieve a significant increase or decrease in speed by taking off and landing on a runway, and another type of current aircrafts that can be lifted in situ has a relatively low flying speed. It is extremely difficult to ensure a safe landing of the aircraft requiring the runway-assisted take-off and landing in the case of a faulty occurring in the air. Therefore, how to balance between an improvement in flight speed and vertical take-off and landing and how to make vehicles safer and more environmentally friendly have become technical problems that need to be addressed urgently.

### SUMMARY OF THE INVENTION

The object of the present disclosure is to provide a fluid-driven device for improving a fluid drive mode.

In order to achieve this object, a fluid-driven device is provided according to an aspect of the present disclosure. The fluid-driven device includes: a transmission portion, which is driven to rotate in an axial direction of the transmission portion; blade portions, which are connected to the transmission portion and rotate in the axial direction of the transmission portion to generate a fluid power; and a pitch portion, which is connected to the blade portions and configured to change a frontal area of the blade portion in its rotation direction in the axial direction of the transmission portion so that the frontal area of the blade portion is switched between a maximum frontal area and a minimum frontal area.

Optionally, the transmission portion includes a sleeve in which a receiving space is provided, the pitch portion is provided in the receiving space, the sleeve is provided with blade mounting holes in a circumferential direction, and the blade portions are connected to the sleeve via the blade mounting holes and are connected to the pitch portion through the blade mounting holes.

Optionally, the pitch portion includes a pitch base and a pitch sliding groove provided around the pitch base, the blade portion is inserted into the pitch sliding groove through the blade mounting hole, and the pitch sliding groove is configured to allow the frontal area of the blade portion to be switched between the maximum frontal area and the minimum frontal area.

Optionally, the pitch sliding groove includes blade fixing sections and pitching sections alternately disposed; in the blade fixing section, the frontal area of the blade portion is maintained at the maximum frontal area or the minimum frontal area; and in the pitching section, the frontal area of blade portion is gradually switched between the maximum frontal area and the minimum frontal area.

Optionally, the pitch portion further includes a blade adjustment shaft extending from one end of the pitch base, and a blade adjustment shaft mounting hole is provided axially inside the sleeve in a penetrating way, wherein the blade adjustment shaft is inserted into the blade adjustment shaft mounting hole, and a relative position relationship between the pitch sliding groove and the receiving space of the sleeve varies as a relative movement between the blade adjustment shaft and the pitch shaft mounting hole varies.

Optionally, the blade portion includes a blade shaft, and a blade and a blade shaft handle respectively provided at two ends of the blade shaft, wherein the blade is provided on the outside of the sleeve, the blade shaft is connected to the sleeve via the blade mounting hole, and the blade shaft handle is inserted into the pitch sliding groove through the blade mounting hole.

Optionally, the transmission portion includes a sleeve in which a receiving space is provided, and the pitch portion includes a pitch notch provided on a wall of the sleeve and a pitch shaft circumferentially inserted into the pitch notch, wherein the blade portion is connected to the pitch shaft and is rotatable with respect to the pitch shaft between the outside of the sleeve and the receiving space.

Optionally, the transmission portion includes a sleeve in which a receiving space is provided, and the pitch portion includes a pitch through hole provided on a wall of the sleeve, wherein the blade portion is inserted into the pitch through hole, and is reciprocally movable with respect to the pitch through hole between the outside of the sleeve and the receiving space.

Optionally, the transmission portion includes a sleeve, and the pitch portion includes a pitch receiving groove provided circumferentially on an outer wall of the sleeve and a pitch shaft axially inserted into the pitch receiving groove, wherein the blade portion is connected to the pitch shaft and is rotatable with respect to the pitch shaft towards or away from the pitch receiving groove.

Optionally, the fluid-driven device further includes a mounting base provided on the outside of the sleeve and rotatably connected to the outside of the sleeve.

With the fluid-driven device according to the present disclosure, a frontal area of the blade portion is adjusted to be maintained at a maximum frontal area in a desired motion direction for interaction with fluid, and is switched to a minimum frontal area in an undesired motion direction to avoid interaction with the fluid as much as possible. In this way, a resistance caused by the fluid is avoided as much as possible, and an action force generated by the fluid is still applied in the desired motion direction and is maximally utilized to promote a motion.

### BRIEF DESCRIPTION OF THE DRAWINGS

FIG. 1 is a schematic diagram of a fluid-driven device according to a first embodiment of the present disclosure;

FIG. 2 is a schematic diagram of a transmission portion of the fluid-driven device in FIG. 1;

FIG. 3 is a schematic diagram of a pitch portion of the fluid-driven device in FIG. 1;

FIG. 4 is a plan view of a pitch sliding groove of the pitch portion in FIG. 3;

FIG. 5 is a schematic diagram of a blade portion of the fluid-driven device in FIG. 1;

FIG. 6 is a schematic diagram of a fluid-driven device according to a second embodiment of the present disclosure;

FIG. 7 is a schematic diagram of a fluid-driven device according to a third embodiment of the present disclosure; and

FIG. 8 is a schematic diagram of a fluid-driven device according to a fourth embodiment of the present disclosure.

### DETAILED DESCRIPTION OF THE EMBODIMENT(S) OF THE INVENTION

A fluid-driven device is provided herein according to an embodiment of the present disclosure. The fluid-driven device includes a transmission portion, blade portions, and a pitch portion. The transmission portion is driven to rotate in an axial direction of the transmission portion. The blade portions are connected to the transmission portion and rotates in the axial direction of the transmission portion. In addition, the pitch portion is connected to the blade portions and is configured to change a frontal area of the blade portion in its rotation direction in the axial direction of the transmission portion so that the frontal area of the blade portion is switched between a maximum frontal area and a minimum frontal area. According to the fluid-driven device in the above embodiment, the blade portions are rotated under the driving of the transmission portion, and the frontal area of the blade portion is adjusted by means of the pitch portion. By a combination of two motion vectors, the frontal area of the rotating blade portion can be maintained at the maximum frontal area in a desired motion direction for interaction with fluid, and a positive force in the desired direction is generated, i.e., the work-doing efficiency is improved as much as possible; and the frontal area of the rotating blade portion is switched to the minimum frontal area in an undesired motion direction to avoid interaction with the fluid as much as possible, and a negative force in the desired motion direction is avoided to be generated, i.e., doing work is avoided as much as possible. For example, when it is desired to raise the fluid-driven device, the frontal area of the rotating blade portion is maintained at the maximum frontal area during a downward rotation to receive as much reaction force generated by the air as possible for raising, and is maintained at the minimum frontal area during an upward rotation to avoid a lowering caused by the reaction force generated by the air as much as possible. During such movement, taking the diameter of the transmission portion as a midline in the fluid-driven device, on one hand, the resistance caused by the fluid is avoided as much as possible, while on the other hand, an action force generated by the fluid is still applied in the desired motion direction and is maximally utilized to promote a motion.

Details of the concept of the present disclosure are described below in conjunction with several embodiments.

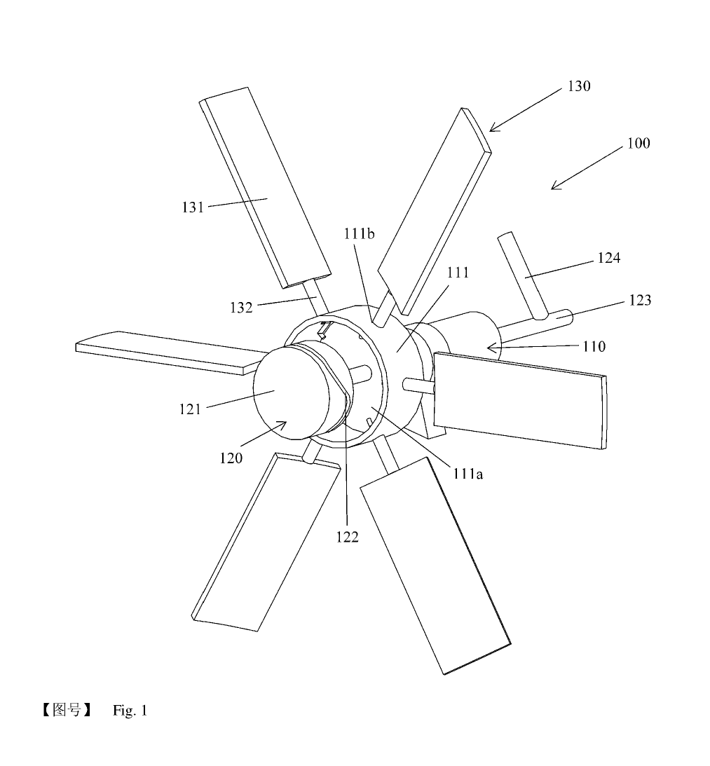

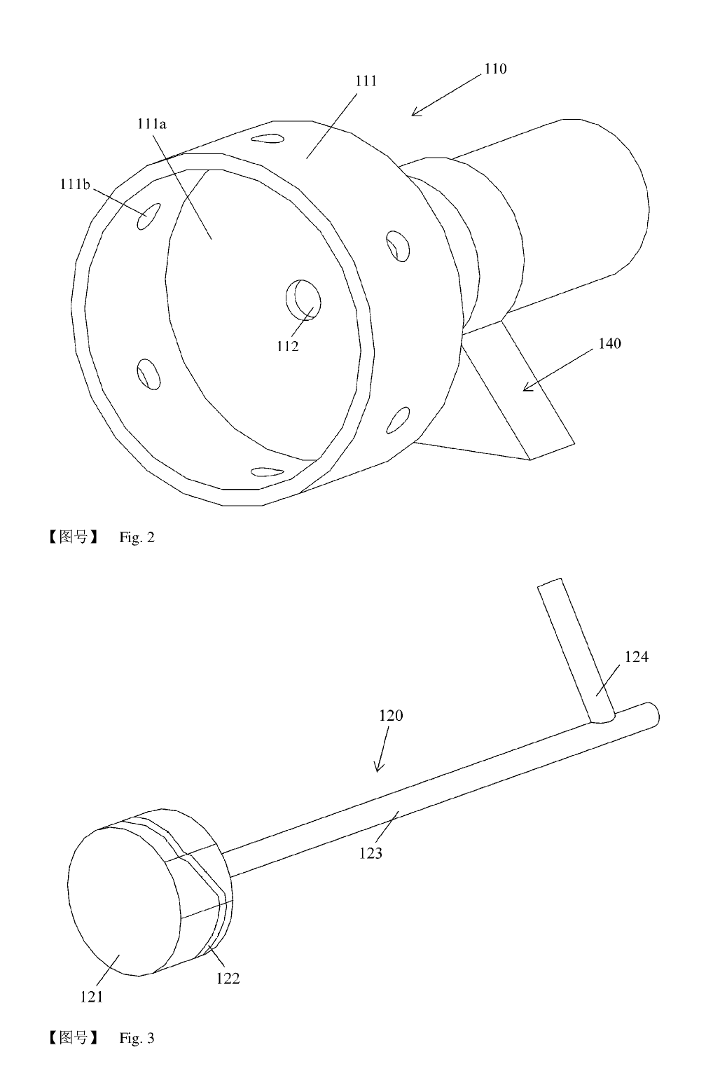

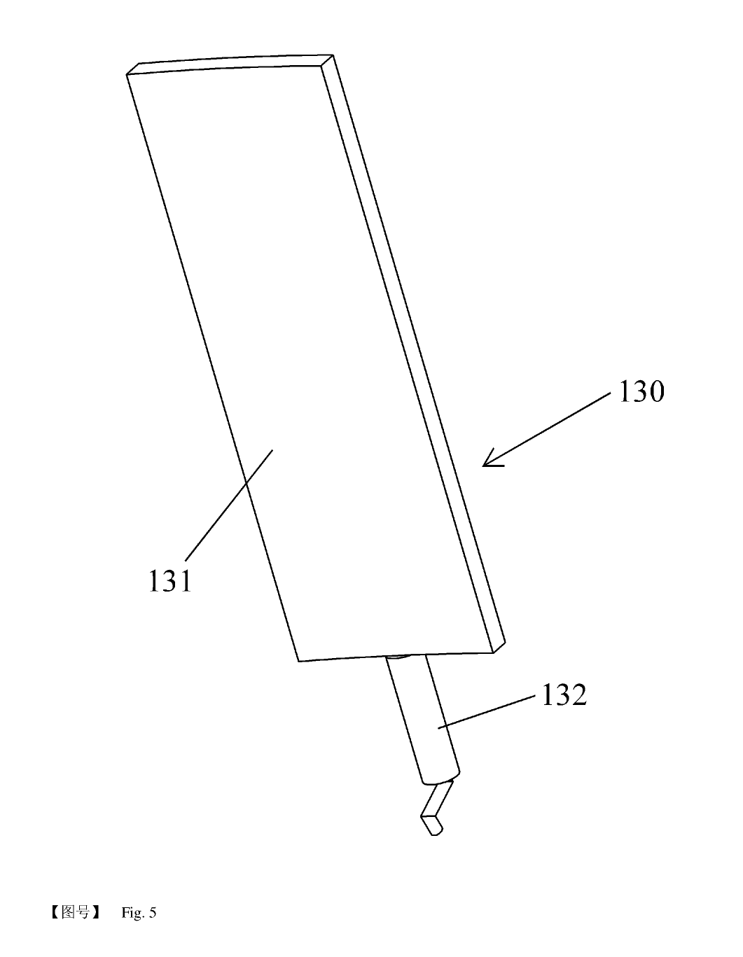

Reference is made to FIG. 1 to FIG. 5, which show a fluid-driven device according to a first embodiment. In the fluid-driven device 100, a transmission portion 110 includes a sleeve 111 in which a receiving space 111a is provided. A pitch portion 120 is provided in the receiving space 111a. The sleeve 111 is provided with blade mounting holes 111b in a circumferential direction. Blade portions 130 are connected to the sleeve 111 via the blade mounting holes 111b, and are further connected to the pitch portion 120 through the blade mounting holes 111b. Blade shaft handles 133 are inserted into a pitch sliding groove 122. Here, a specific structure of the transmission portion is provided. In this structure, an interconnection among the pitch portion, the blade portions and the transmission portion is achieved, thereby effectively ensuring a combination of a rotary motion and a pitch motion according to the present concept.

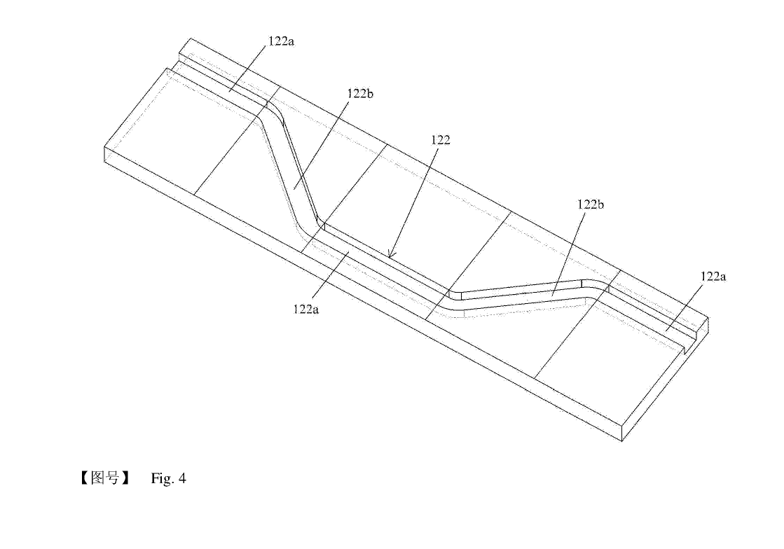

As a more specific structure, the pitch portion 120 includes a pitch base 121 and a pitch sliding groove 122 provided around the pitch base 121. In this case, the blade shaft handles 133 of the blade portions 130 are inserted into the pitch sliding groove 122 through the blade mounting holes 111b. The pitch sliding groove 122 is configured to switch a frontal area of the blade portion 130 between a maximum frontal area and a minimum frontal area. A specific example is provided herein to illustrate how to configure the pitch sliding groove. For example, the pitch sliding groove 122 includes blade fixing sections 122a and pitching sections 122b alternately disposed. In the blade fixing section 122a, the frontal area of the blade portion 130 is maintained at the maximum frontal area or the minimum frontal area. In the pitching section 122b, the frontal area of the blade portion 130 is gradually switched between the maximum frontal area and the minimum frontal area. Referring to FIG. 4, in this example, since the frontal area of the blade portion is stably maintained at the maximum frontal area or the minimum frontal area when the blade portion is in the fixing section, the fixing section 122a is configured as two straight line sections parallel with each other. Since the frontal area of the blade portion may be switched from the maximum frontal area to the minimum frontal area or from the minimum frontal area to the maximum frontal area when the blade portion is in the pitching section, the pitching section 122b is configured as oblique straight line sections connecting ends of two adjacent fixing sections 122a. A closed-loop sliding groove should be formed by the fixing sections and the pitching sections, so that the blade shaft handle 133 at the end of the blade portion can continuously slide in the sliding groove. In addition, since the blade portion of the fluid-driven device mainly does work in the predetermined blade fixing section 122a, the efficiency of converting mechanical power into aerodynamic power is improved as the above pitching section is shorted, i.e., a switching period is shorted.

Furthermore, a multi-directional navigation is desired to be achieved with the fluid-driven device. Therefore, it is desired that relative positions of the blade fixing section 122a and the pitching section in an inner circumference of the sleeve may vary. In this case, the pitch portion 120 further includes a blade adjustment shaft 123 extending from one end of the pitch base 121, and a blade adjustment shaft mounting hole 112 for the blade adjustment shaft 123 is provided axially inside the sleeve 111 in a penetrating way. The blade adjustment shaft 123 is inserted into the blade adjustment shaft mounting hole 112. In this configuration, a relative position relationship between the pitch sliding groove 122 and the receiving space 111a of the sleeve 111 varies as a relative movement between the blade adjustment shaft 123 and the blade adjustment shaft mounting hole 112 for the blade adjustment shaft 123 varies. In this way, a navigation direction can be adjusted as required. Referring to FIG. 3, as an additional improvement, a blade adjustment handle 124 is further provided at a second end of the blade adjustment shaft 123 to facilitate operations in the blade adjustment process. In addition, it should be understood that the blade adjustment shaft 123 should be fixed at a designated position when it is not required to adjust the navigation direction, thereby ensuring an unchanged navigation attitude.

Further, for another part, the blade portion 130 includes a blade 131, a blade shaft 132 provided at an inner end of the blade 131, and a blade shaft handle 133 extending from the blade shaft 132. The blade 131 is provided on the outside of the sleeve 111, the blade shaft 132 is connected to the sleeve 111 through the blade mounting hole 111b, and the blade shaft handle 133 is inserted into the pitch sliding groove 122 through the blade mounting hole 111b. In this configuration, the blade 131 primarily serves to interact with the air to generate a force in a designated direction, while the blade shaft 132 mainly serves to connect and fix the blade 131 and twist repeatedly. It should be noted that in this embodiment, the blade shaft handle should be configured to fit with the pitch sliding groove. In addition, while six blades 131 are shown herein in the drawings as an example, the number of blades may actually be increased or decreased based on design and needs, and the total number of the blades is not limited to an even number.

In addition, the fluid-driven device 100 further includes a mounting base 140 provided on the outside of the sleeve 111. The mounting base is rotatably connected to the outside of the sleeve 111. For example, the mounting base may be connected to the outside of the sleeve 111 via ball bearings. The mounting base is, on one hand, configured to fix the fluid-driven device and a device to be driven, and on the other hand, will not impede a rotating torque transmitted from the sleeve to the blade portion.

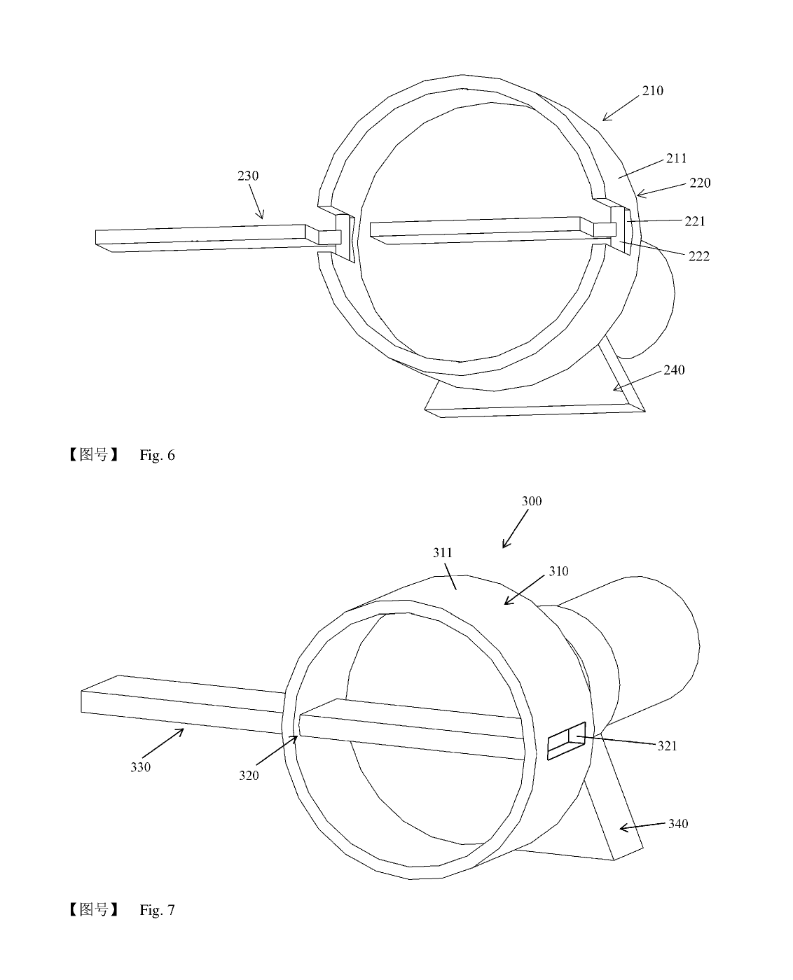

Reference is made to FIG. 6, which shows a fluid-driven device according to a second embodiment. Since the structure of the pitch portion of the fluid-driven device is changed, the transmission portion and the blade portion of the fluid-driven device are also changed adaptively. Modifications to the fluid-driven device are mainly described below, and other details similar to those of the foregoing embodiment are not described hereinafter.

A transmission portion 210 of a fluid driving device 200 includes a sleeve 211 in which a receiving space is provided. A pitch portion 220 includes a pitch notch 221 provided on a wall of the sleeve and a pitch shaft 222 circumferentially inserted into the pitch notch. A blade portion 230 is connected to the pitch shaft 222 and is rotatable with respect to the pitch shaft 222 between the outside of the sleeve 211 and the receiving space. In this case, when being on the outside of the sleeve 211, the blade portion 230 will interact with the air to do work. When being in the receiving space inside the sleeve 211, no interaction force exists between the blade portion 230 and the air. Therefore, based on the principles taught above, the blade portion 230 should be rotated to the outside of the sleeve 211 in a direction in which the force is desired to be applied, whereas the blade portion 230 is rotated to the receiving space inside the sleeve 211 in a direction in which no opposite-direction force is desired, and it would be better if the switching process is as fast as possible. Therefore, in the fluid-driven device according to this embodiment, the resistance caused by a fluid is also avoided as much as possible, and the action force generated by the fluid is still applied in the desired motion direction and is maximally utilized to promote a motion.

Reference is made to FIG. 7, which shows a fluid-driven device according to a third embodiment. Since the fluid-driven device is also changed mainly in terms of the structure of the pitch portion, the transmission portion and the blade portion of the fluid-driven device are also changed adaptively. Similarly, modifications to the fluid-driven device are mainly described below, and other details similar to those of the foregoing embodiments are not described hereinafter.

In a fluid driving device 300, a transmission portion 310 includes a sleeve 311 in which a receiving space is provided, and a pitch portion 320 includes a pitch through hole 321 provided on a wall of the sleeve 311. A blade portion 330 is inserted into the pitch through hole 321 and is reciprocally movable with respect to the pitch through hole 321 between the outside of the sleeve 311 and the receiving space. In this case, when being on the outside of the sleeve 311, the blade portion 330 will interact with the air to do work. When being in the receiving space inside the sleeve 311, no interaction force exists between the blade portion 330 and the air. Therefore, based on the principles taught above, the blade portion 330 should be translated to the outside of the sleeve 311 in a direction in which the force is desired to be applied, whereas the blade portion 330 should be translated to the receiving space inside the sleeve 311 in a direction in which no opposite-direction force is desired, and it would be better if the switching process is as fast as possible. Therefore, similarly, in the fluid-driven device according to this embodiment, the resistance caused by a fluid is also avoided as much as possible, and the action force generated by the fluid is still applied in the desired motion direction and is maximally utilized to promote a motion.

As a variation of this embodiment, symmetric pitch through holes 321 may also be provided on a wall of the sleeve 311. In this way, during a switching process of the blade portion 330, as the blade portion 330 on one side that is exposed to the outside of the sleeve 311 is retracted, the other part of the blade portion 330 will simultaneously protrude from the receiving space to the outside of the sleeve 311 in an opposite direction, and the desired work-doing effect is also achieved.

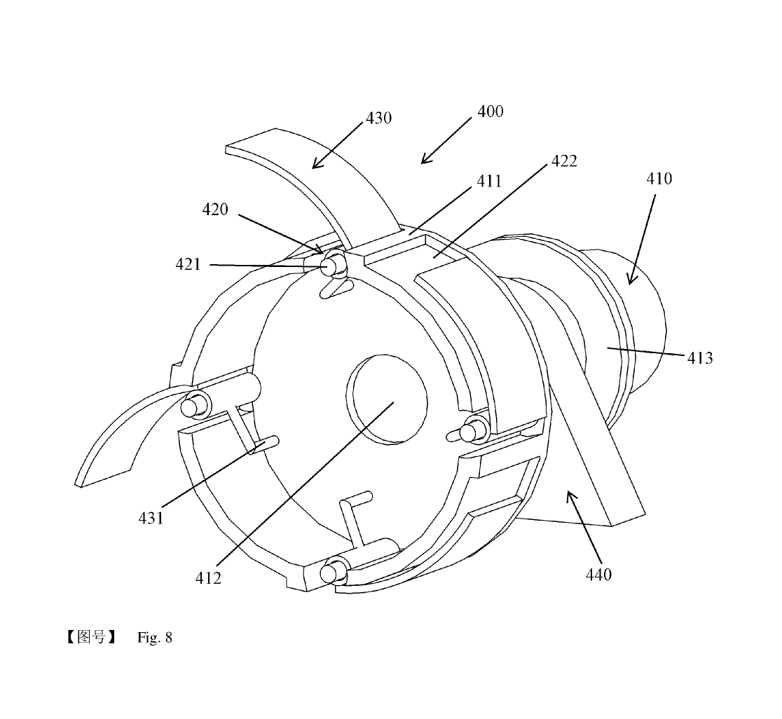

Reference is made to FIG. 8, a fluid-driven device according to a fourth embodiment is further provided. Since the fluid-driven device is also changed mainly in terms of the structure of the pitch portion, the transmission portion and the blade portion of the fluid-driven device are also changed adaptively. Similarly, modifications to the fluid-driven device are mainly described below, and other details similar to those of the foregoing embodiments are not described hereinafter.

In a fluid-driven device 400, a transmission portion 410 includes a sleeve 411, and a pitch portion 420 includes a pitch receiving groove 422 provided circumferentially on an outer wall of the sleeve 411 and a pitch shaft 421 axially inserted into the pitch receiving groove 422. A blade portion 430 is connected to the pitch shaft 421 and is rotatable with respect to the pitch shaft 421 towards or away from the pitch receiving groove 422. A mounting hole 412 is provided at the middle of the transmission portion 410, and a pitch sheave is inserted into the mounting hole 412. A pitch sliding groove is further provided on the pitch sheave, and the pitch sliding groove cooperates with a blade shaft handle 431 at the distal end of the blade portion 430. In this way, with a driving by a pulley 413 in the transmission portion 410, the blade portion 430 also moves through a cooperation of the blade shaft handle 431 with the pitch sliding groove. When being on the outside of the sleeve 411, the blade portion 430 will interact with the air to do work. When being in the pitch receiving groove 422 on the outer wall of the sleeve 411, no interactive force exists between the blade portion 430 and the air. Therefore, based on the principles taught above, the blade portion should be rotated to the outside of the sleeve in a direction in which the force is desired to be applied until it is unfolded, whereas the blade portion 330 should be rotated in a direction in which no opposite-direction force is desired until it is hidden in the pitch receiving groove, and it would be better if the switching process is as fast as possible. Therefore, similarly, in the fluid-driven device according to this embodiment, the resistance caused by a fluid is also avoided as much as possible, and the action force generated by the fluid is still applied in the desired motion direction and is maximally utilized to promote a motion.

It should be understood that, while an aircraft is mainly taken as a drive object of the fluid-driven device, and the air is taken as an involved fluid object, the present disclosure is in fact also applicable to the fields of navigation, diving, and the like. Both water and air should be regarded as the fluid to be driven mentioned herein.

Further, the orientation terms such as upper, lower, left, right, front, rear, front surface, back surface, top, bottom, midline, and the like, appearing or possibly appearing in the specification, are defined relative to the configurations shown in individual drawings, and they are relative concepts. In this case, corresponding changes may be made based on different positions and different usage states. Therefore, these or other orientation terms should not be interpreted as restrictive terms.

The fluid-driven devices according to the present disclosure are mainly described in the above examples. While only some of the embodiments of the present disclosure have been described, those skilled in the art will understand that the present disclosure can be carried out in many other forms without departing from the spirit and scope thereof. Therefore, the illustrated examples and embodiments should be considered as illustrative rather than limiting, and the present disclosure can cover various modifications and replacements without departing from the spirit and scope of the present disclosure defined by individual appended claims.

What is claimed is:

1. A fluid-driven device, comprising:
a transmission portion, which is driven to rotate in an axial direction of the transmission portion;
blade portions, which are connected to the transmission portion and rotate in the axial direction of the transmission portion; and
a pitch portion, which is connected to the blade portions and configured to change a frontal area of the blade portion in its rotation direction in the axial direction of the transmission portion so that the frontal area of the blade portion is switched between a maximum frontal area and a minimum frontal area.

2. The fluid-driven device according to claim 1, wherein the transmission portion comprises a sleeve in which a receiving space is provided, the pitch portion is provided in the receiving space, the sleeve is provided with blade mounting holes in a circumferential direction, and the blade portions are connected to the sleeve via the blade mounting holes and are connected to the pitch portion through the blade mounting holes.

3. The fluid-driven device according to claim 2, wherein the pitch portion comprises a pitch base and a pitch sliding groove provided around the pitch base, the blade portion is inserted into the pitch sliding groove through the blade mounting hole, and the pitch sliding groove is configured to allow the frontal area of the blade portion to be switched between the maximum frontal area and the minimum frontal area.

4. The fluid-driven device according to claim 3, wherein the pitch sliding groove comprises blade fixing sections and pitching sections alternately disposed; in the blade fixing section, the frontal area of the blade portion is maintained at the maximum frontal area or the minimum frontal area; and in the pitching section, the frontal area of blade portion is gradually switched between the maximum frontal area and the minimum frontal area.

5. The fluid-driven device according to claim 3, wherein the pitch portion further comprises a blade adjustment shaft extending from one end of the pitch base, and a blade adjustment shaft mounting hole is provided axially inside the sleeve in a penetrating way, wherein the blade adjustment shaft is inserted into the blade adjustment shaft mounting hole, and a relative position relationship between the pitch sliding groove and the receiving space of the sleeve varies as a relative movement between the blade adjustment shaft and the pitch shaft mounting hole varies.

6. The fluid-driven device according to claim 3, wherein the blade portion comprises a blade shaft, and a blade and a blade shaft handle respectively provided at two ends of the blade shaft, wherein the blade is provided on the outside of the sleeve, the blade shaft is connected to the sleeve via the blade mounting hole, and the blade shaft handle is inserted into the pitch sliding groove through the blade mounting hole.

7. The fluid-driven device according to claim 1, wherein the transmission portion comprises a sleeve in which a receiving space is provided, and the pitch portion comprises a pitch notch provided on a wall of the sleeve and a pitch shaft circumferentially inserted into the pitch notch, wherein the blade portion is connected to the pitch shaft and is rotatable with respect to the pitch shaft between the outside of the sleeve and the receiving space.

8. The fluid-driven device according to claim 1, wherein the transmission portion comprises a sleeve in which a receiving space is provided, and the pitch portion comprises a pitch through hole provided on a wall of the sleeve, wherein the blade portion is inserted into the pitch through hole, and is reciprocally movable with respect to the pitch through hole between the outside of the sleeve and the receiving space.

9. The fluid-driven device according to claim 1, wherein the transmission portion comprises a sleeve, and the pitch portion comprises a pitch receiving groove provided circumferentially on an outer wall of the sleeve and a pitch shaft axially inserted into the pitch receiving groove, wherein the blade portion is connected to the pitch shaft and is rotatable with respect to the pitch shaft towards or away from the pitch receiving groove.

10. The fluid-driven device according to any one of claims 2 to 9, further comprising a mounting base provided on the outside of the sleeve and rotatably connected to the outside of the sleeve.
